(19) United States
(12) Patent Application Publication
(10) Pub. No.: US 2026/0103175 A1
(43) Pub. Date: Apr. 16, 2026

(54) RESERVOIR TANK AND ELECTRONIC BRAKE SYSTEM INCLUDING THE SAME

(71) Applicant: HL MANDO CORPORATION, Pyeongtaek-si (KR)

(72) Inventor: Heonjae SONG, Pyeongtaek-si (KR)

(21) Appl. No.: 19/016,123

(22) Filed: Jan. 10, 2025

(30) Foreign Application Priority Data
Oct. 15, 2024 (KR) 10-2024-0140104

(51) Int. Cl. B60T 11/26; B60T 17/22

(52) U.S. Cl. CPC B60T 11/26; B60T 17/225

(57) ABSTRACT

Disclosed are a reservoir tank and an electronic brake system including the same. A reservoir tank according to an embodiment of the present disclosure includes an upper casing including an upper flange provided at a lower side thereof, and upper reinforcement ribs provided along an outer peripheral surface of the upper flange, and a lower casing including a lower flange provided at an upper side thereof, and lower reinforcement ribs provided along an outer peripheral surface of the lower flange, the lower casing being coupled to the lower side of the upper casing to form an internal space in which brake oil is stored, in which the upper reinforcement rib and the lower reinforcement rib are disposed on a straight line.

This application claims the priority of Korean Patent Application No. 10-2024-0140104 filed on October 15, 2024, in the Korean Intellectual Property Office, the disclosure of which is incorporated herein by reference.

### BACKGROUND

### TECHNICAL FIELD

The present disclosure relates to a reservoir tank and an electronic brake system including the same, and more particularly, to a reservoir tank, which is capable of storing brake oil to be supplied to a master cylinder of a brake, and an electronic brake system including the same.

### DESCRIPTION OF THE RELATED ART

A vehicle is essentially equipped with a brake system for braking the vehicle. Various types of brake systems have been proposed to provide safety for a driver and an occupant.

The brake system in the related art mainly operates in such a way that when the driver pushes a brake pedal, a booster mechanically connected to the brake pedal is used to supply a wheel cylinder with a liquid pressure required to brake the vehicle. However, as there is an increasing demand from the market to implement various braking functions in order to cope with operational environments of vehicles, electronic brake systems have recently widely proliferated, in which when a driver pushes a brake pedal, a pedal displacement sensor, which detects a displacement of the brake pedal, transmits an electrical signal to indicate a driver's intention to brake, and a liquid pressure generation device operates in response to the electrical signal to supply a wheel cylinder with a liquid pressure required to brake the vehicle.

More specifically, the electronic brake system includes a configuration in which a pedal displacement sensor operates a motor by outputting an operation of a brake pedal as an electrical signal, a piston pump of a liquid pressure generation device generates hydraulic braking pressure in accordance with an operation of the motor, and an electronic control unit (ECU) controls the hydraulic pressure and transmits the hydraulic pressure to wheels. In addition, in order to transmit a pedal effort of the brake pedal directly to the wheel cylinder when the electronic brake system operates abnormally, the electronic brake system may include a master cylinder provided in a hydraulic pressure block equipped with a hydraulic circuit, and a reservoir tank configured to supply brake oil to the master cylinder.

### BRIEF SUMMARY

In general, in order to define an internal space in which the brake oil is stored, the reservoir tank may include an upper casing formed as an injection-molded product, and a lower casing fastened to the upper casing. Because the upper casing and the lower casing of the reservoir tank are formed as injection-molded products as described above, it is difficult to maintain quality because the upper and lower casings are contracted and deformed by being cooled after injection-molding, the upper and lower casings are deformed when the upper and lower casings are ejected from molds, and the upper and lower casings are warped when a hot plate for coupling the upper and lower casings is fused.

In particular, because the reservoir tank is exposed to various environmental conditions over a long period of time, there is a problem in that the brake oil often leaks because a fastened portion between the upper casing and the lower casing is deformed.

Various embodiments of the present disclosure to provide a reservoir tank, which is capable of preventing deformation occurring when upper and lower casings for forming an internal space in which brake oil is stored are manufactured, and an electronic brake system including the same.

Various embodiments of the present disclosure to provide a reservoir tank, which is capable of easily aligning upper and lower casings to couple the upper and lower casings for forming an internal space in which brake oil is stored, and an electronic brake system including the same.

Various embodiments of the present disclosure to provide a reservoir tank, which is capable of preventing a leak of brake oil even though the reservoir tank is exposed to various environmental conditions over a long period of time, and an electronic brake system including the same.

A reservoir tank according to an embodiment of the present disclosure includes: an upper casing including an upper flange provided at a lower side thereof, and upper reinforcement ribs provided along an outer peripheral surface of the upper flange; and a lower casing including a lower flange provided at an upper side thereof, and lower reinforcement ribs provided along an outer peripheral surface of the lower flange, the lower casing being coupled to the lower side of the upper casing to form an internal space in which brake oil is stored, in which the upper reinforcement rib and the lower reinforcement rib are disposed on a straight line.

The upper casing and the lower casing may be provided by injection-molding a synthetic resin material.

The upper casing may further include upper inner ribs protruding from the upper flange toward the internal space, and the lower casing may further include lower inner ribs protruding from the lower flange toward the internal space.

The upper casing may be coupled to the lower casing by thermally bonding upper surfaces of the lower flange and the lower inner ribs and bottom surfaces of the upper flange and the upper inner ribs.

The upper reinforcement rib may extend upward by a preset height from an upper surface of the upper flange along an outer surface of the upper casing, and the lower reinforcement rib may extend downward by a preset height from a bottom surface of the lower flange along an outer surface of the lower casing.

The upper reinforcement ribs and the upper inner ribs may be disposed in a staggered manner in a longitudinal direction of the upper inner ribs extending from the upper flange, and the lower reinforcement ribs and the lower inner ribs may be disposed in a staggered manner in a longitudinal direction of the lower inner ribs extending from the lower flange.

A height of the upper flange may be equal to a height of the lower flange.

A height of the upper rib and a height of the lower rib may be 1.2 to 3.5 times larger than a height of the upper flange or a height of the lower flange.

The upper casing may further include: an injection port provided at a rear upper side of the upper casing to inject the brake oil into the internal space; a filter assembly provided to be detachable from the injection port toward the internal space; a gasket provided at an upper side of the filter assembly and configured to cover the injection port; and an injection port cap configured to open or close the injection port.

The lower casing may further include: a float chamber formed by a float guide provided in the internal space; and a float inserted into the float chamber and configured to move upward or downward in accordance with a level of the brake oil stored in the internal space.

The float guide may include a protrusion protruding from an inner peripheral surface toward the float chamber, and the float may be provided in a cylindrical shape and include a float slot formed in an outer peripheral surface so that the protrusion is inserted into the float slot.

The float may include a magnet provided at a bottom surface side, and the lower casing may further include a switch fastening part provided adjacent to the magnet and configured to fasten a switch configured to detect the level of the brake oil, which is stored in the internal space, on the basis of a magnetic force generated by the magnet.

The lower casing may further include: at least one fastening hole; and a hydraulic block fastening part including at least one port and provided at a front surface side of the lower casing.

The fastening holes may include first and second fastening holes provided to have central axes intersecting each other perpendicularly.

An electronic brake system according to another embodiment of the present disclosure includes: a reservoir tank, in which reservoir tank includes: an upper casing including an upper flange provided at a lower side thereof, and upper reinforcement ribs provided along an outer peripheral surface of the upper flange; and a lower casing including a lower flange provided at an upper side thereof, and lower reinforcement ribs provided along an outer peripheral surface of the lower flange, the lower casing being coupled to the lower side of the upper casing to form an internal space in which brake oil is stored, and in which the upper reinforcement rib and the lower reinforcement rib are disposed on a straight line.

The upper casing may further include upper inner ribs protruding from the upper flange toward the internal space, the lower casing may further include lower inner ribs protruding from the lower flange toward the internal space, and the upper casing may be coupled to the lower casing by thermally bonding upper surfaces of the lower flange and the lower inner ribs and bottom surfaces of the upper flange and the upper inner ribs.

The upper reinforcement rib may extend upward by a preset height from an upper surface of the upper flange along an outer surface of the upper casing, and the lower reinforcement rib may extend downward by a preset height from a bottom surface of the lower flange along an outer surface of the lower casing.

A height of the upper flange may be equal to a height of the lower flange.

A height of the upper rib and a height of the lower rib may be 1.2 to 3.5 times larger than a height of the upper flange or a height of the lower flange.

The upper reinforcement ribs and the upper inner ribs may be disposed in a staggered manner in a longitudinal direction of the upper inner ribs extending from the upper flange, and the lower reinforcement ribs and the lower inner ribs may be disposed in a staggered manner in a longitudinal direction of the lower inner ribs extending from the lower flange.

According to the reservoir tank and the electronic brake system including the same according to the present embodiment, it is possible to prevent deformation of the upper and lower casings when the upper and lower casings for forming the internal space in which the brake oil is stored are manufactured, which may reduce costs required to manufacture the reservoir tank.

According to the reservoir tank and the electronic brake system including the same according to the present embodiment, it is possible to easily align the upper and lower casings to couple the upper and lower casings for forming the internal space in which the brake oil is stored, which may improve the process efficiency in manufacturing the reservoir tank.

According to the reservoir tank and the electronic brake system including the same according to the present embodiment, a leak of the brake oil is prevented even though the reservoir tank is exposed to various environmental conditions over a long period of time, such that the reliability of the reservoir tank may be significantly improved.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### DRAWINGS BRIEF DESCRIPTION OF THE SEVERAL VIEWS OF THE DRAWINGS

The above and other aspects, features and other advantages of the present disclosure will be more clearly understood from the following detailed description taken in conjunction with the accompanying drawings, in which:

FIG. 1 is a schematic view illustrating an overall configuration of an electronic brake system including a reservoir tank according to an embodiment of the present disclosure;

FIG. 2 is a perspective top plan view illustrating a state in which the reservoir tank according to the embodiment of the present disclosure is disassembled;

FIG. 3 is a perspective bottom plan view illustrating a state in which the reservoir tank according to the embodiment of the present disclosure is disassembled;

FIG. 4 is a top plan view illustrating an upper casing of the reservoir tank according to the embodiment of the present disclosure;

FIG. 5 is a bottom plan view illustrating a lower casing of the reservoir tank according to the embodiment of the present disclosure;

FIG. 6 is a perspective top plan view of the reservoir tank according to the embodiment of the present disclosure;

FIG. 7 is a perspective bottom plan view of the reservoir tank according to the embodiment of the present disclosure;

FIG. 8 is a front view of the reservoir tank according to the embodiment of the present disclosure;

FIG. 9 is a left side view of the reservoir tank according to the embodiment of the present disclosure;

FIG. 10 is a right side view of the reservoir tank according to the embodiment of the present disclosure; and

FIG. 11 is a rear view of the reservoir tank according to the embodiment of the present disclosure.

### DETAILED DESCRIPTION

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

The shapes, sizes, dimensions (e.g., length, width, height, thickness, radius, diameter, area, etc.), ratios, angles, number of elements, and the like illustrated in the accompanying drawings for describing the embodiments of the present disclosure are merely examples, and the present disclosure is not limited thereto.

A dimension including size and a thickness of each component illustrated in the drawing are illustrated for convenience of description, and the present disclosure is not limited to the size and the thickness of the component illustrated, but it is to be noted that the relative dimensions including the relative size, location, and thickness of the components illustrated in various drawings submitted herewith are part of the present disclosure.

Hereinafter, embodiments of the present disclosure will be described in detail with reference to the accompanying drawings. The following embodiments are presented to sufficiently provide the spirit of the present disclosure to those skilled in the art to which the present disclosure pertains. The present disclosure is not limited to the embodiments presented herein and may be specified as other aspects. The constituent elements irrelevant to the description of the present disclosure will be omitted from the drawings to clearly describe the present disclosure. For some figures, the sizes of the constituent elements may be somewhat exaggerated for purposes of understanding.

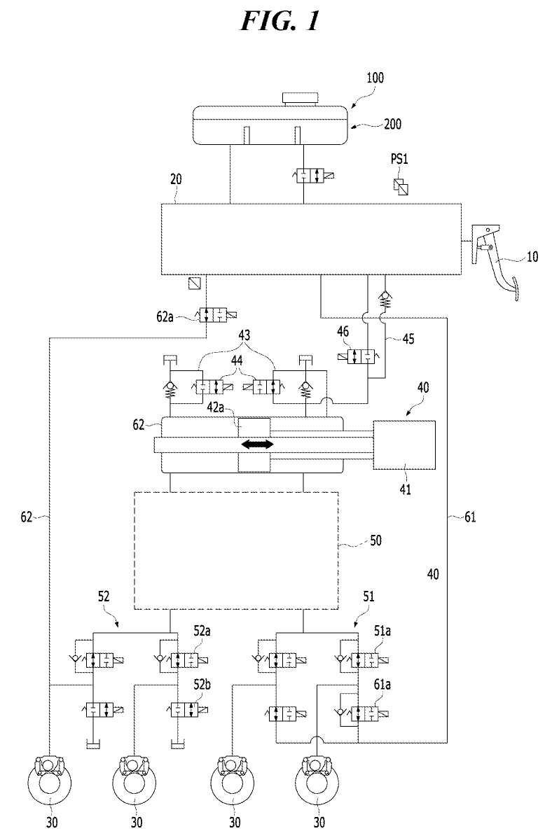

FIG. 1 is a schematic view illustrating an overall configuration of an electronic brake system including a reservoir tank according to an embodiment of the present disclosure. With reference to FIG. 1, an electronic brake system including a reservoir tank 1 according to the embodiment of the present disclosure may include a master cylinder 20 configured to press and discharge brake oil accommodated therein while simultaneously providing a driver with a reaction force in response to a pedal effort of a brake pedal 10, wheel cylinders 30 configured to receive liquid pressure of the brake oil and brake vehicle wheels RR, RL, FR, and FL, an actuator 40 configured to generate the liquid pressure of the brake oil while mechanically operating by receiving a driver's intention to brake as an electrical signal from a pedal displacement sensor PS1 configured to detect a displacement of the brake pedal 10, a hydraulic control unit 50 configured to control the liquid pressure to be transmitted to the wheel cylinders 30, and an electronic control unit (ECU, not illustrated) configured to control the actuator 40 and various types of valves on the basis of liquid pressure information and pedal displacement information.

The master cylinder 20 is supplied with the brake oil from reservoir tanks 100 and 200 to be described below according to the embodiment of the present disclosure. When the driver applies the pedal effort to the brake pedal 10 to perform a braking operation, the master cylinder 20 is configured to press and discharge the brake oil accommodated therein while simultaneously providing stable pedal feel by providing the driver with the reaction force in response to the pedal effort.

To this end, the master cylinder 20 may include a simulation part (not illustrated) configured to provide pedal feel to the driver, and a master cylinder part (not illustrated) configured to press and discharge the brake oil accommodated therein by means of the pedal effort of the brake pedal 10. Although not illustrated in detail, the simulation part and the master cylinder part may be integrally disposed coaxially in a single housing or separately provided and then coupled to each other. More specifically, the master cylinder part includes at least one master chamber (typically, two master chambers) in a housing and presses and discharges the brake oil to the master chamber when a master piston connected to the brake pedal moves forward and rearward. The simulation part operates in conjunction with the master piston. For example, the simulation part is made of an elastic material and provides the driver with the pedal feel of the brake pedal by using an elastic restoring force.

The wheel cylinder 30 will be more specifically described with reference to the description of the hydraulic control unit 50 that controls the liquid pressure to be transmitted to the four vehicle wheels to be described below.

The actuator 40 is a typical liquid pressure supply device configured to generate the liquid pressure of the brake oil while mechanically operating by receiving the driver's intention to brake as an electrical signal from the pedal displacement sensor PS1 configured to detect the displacement of the brake pedal 10. To this end, the actuator 40 may include a drive part 41 configured to be operated in response to the electrical signal from the pedal displacement sensor PS1, and a liquid pressure generation device 42 configured to provide pressure to the brake oil to be transmitted to the wheel cylinder 30 by an operation of a motor of the drive part.

The motor of the drive part 41 is configured to operate a piston 42a of the liquid pressure generation device 42 in response to an electrical signal outputted from the electronic control unit. The motor may include a stator and a rotor. The motor may provide power for displacing the piston 42a while operating forward or reversely. A rotation angular velocity and a rotation angle of the motor may be precisely controlled by a motor control sensor. Because the motor is a technology already publicly known widely, a detailed description thereof will be omitted.

For example, the liquid pressure generation device 42 may include a ball screw nut configured to convert a rotational force, which is generated by the operation of the motor of the drive part 41, into a rectilinear motion, and a linear pump configured to be pressed by the ball screw nut. That is, the actuator 40 generates braking pressure by operating the motor and moving a piston of the linear pump forward and rearward in response to the electrical signal from the pedal displacement sensor PS1.

A dump flow path 43 and a dump valve 44 may be provided between the actuator 40 and the reservoir tank according to the embodiment of the present disclosure to control a flow of a pressing medium. In addition, a test flow path 45 and a test valve 46 may be provided between the actuator 40 and the master cylinder 20 to check whether a leak occurs.

The hydraulic control unit 50 may include the first and second hydraulic circuits 51 and 52 each configured to control the two vehicle wheels by receiving the liquid pressure from the actuator 40. For example, the first hydraulic circuit 51 may control the right front wheel FR and the left rear wheel RL, and the second hydraulic circuit 52 may control the left front wheel FL and the right rear wheel RR. The wheel cylinders 30 are respectively installed in the vehicle wheels FR, FL, RR, and RL and brake the vehicle wheels FR, FL, RR, and RL by receiving the liquid pressure. More specifically, the hydraulic control unit 50 may include inlet valves 51a and 52a provided at front ends of the wheel cylinders 30 and configured to control the liquid pressure, and outlet valves 52b branching off between the inlet valves 51a and 52a and the wheel cylinder 30 and connected to the reservoir tank according to the embodiment of the present disclosure.

In addition, the electronic brake system, to which the reservoir tank according to the present embodiment is applied, may further include back-up flow paths 61 and 62 configured to implement the braking operation by the driver by supplying the brake oil, which is discharged from the master cylinder 20, directly to the wheel cylinders 30 in case that the actuator 40 does not operate normally. One or more valves 61a and 62a may be provided in the back-up flow paths 61 and 62 and control the flow of the pressing medium between the wheel cylinder 30 and the master cylinder 20.

Because of the braking operation and the braking-releasing operation of the electronic brake system with the above-mentioned structure are publicly-known technologies, a detailed description thereof will be omitted.

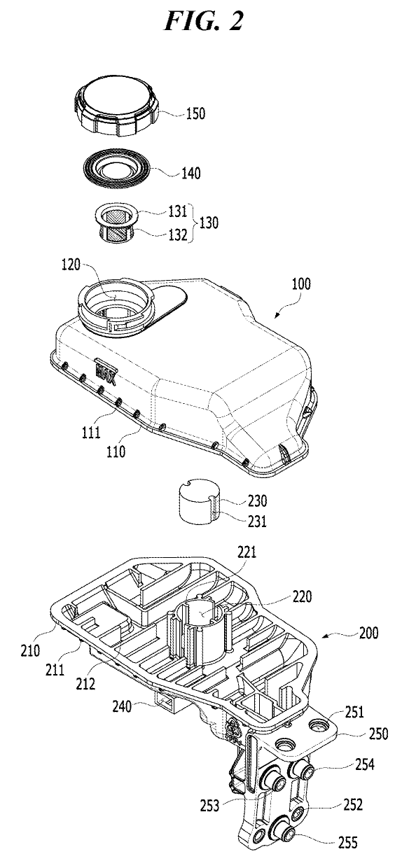

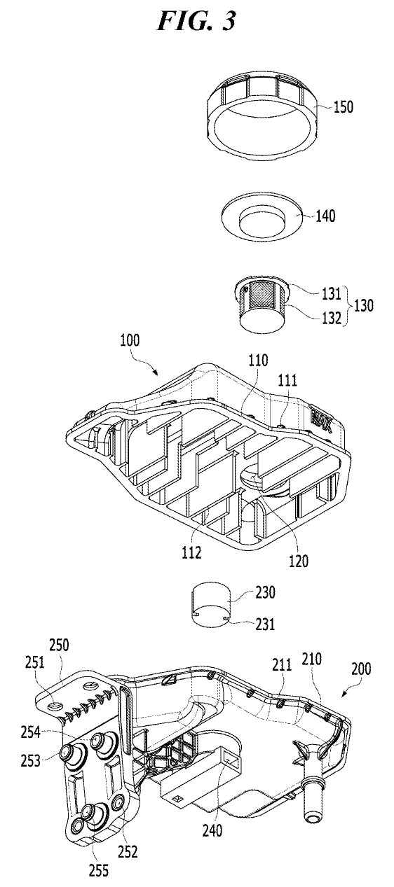

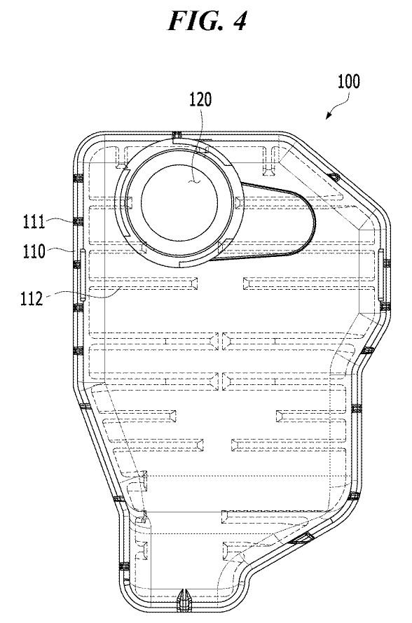

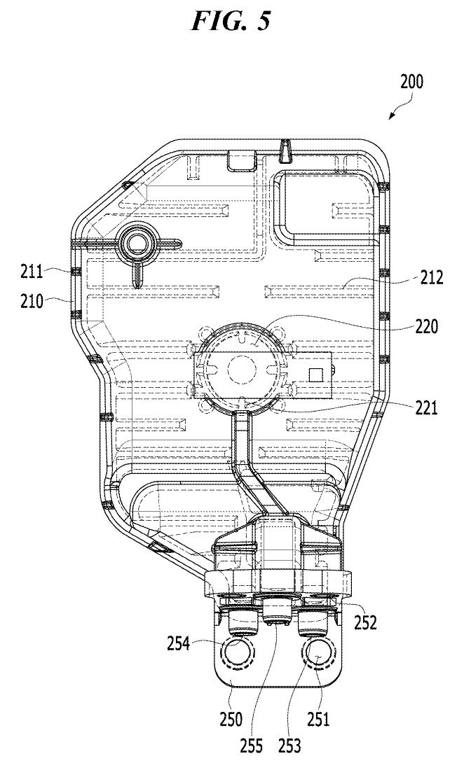

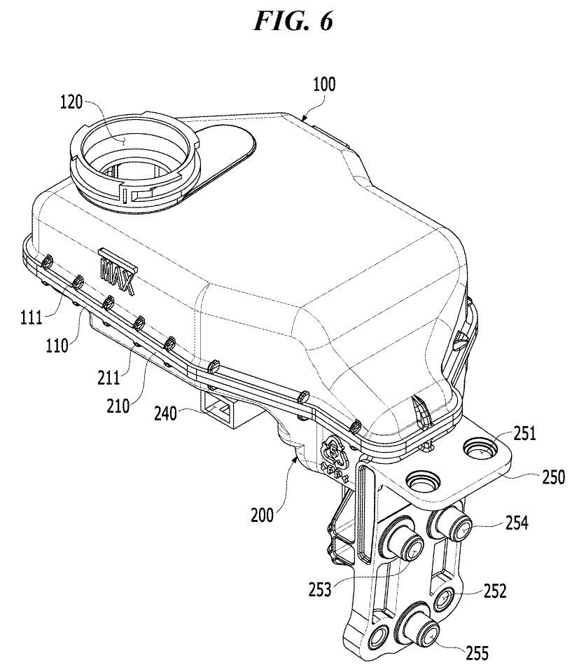

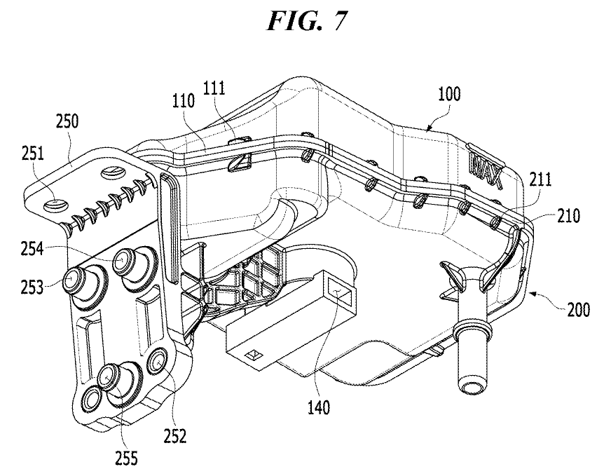

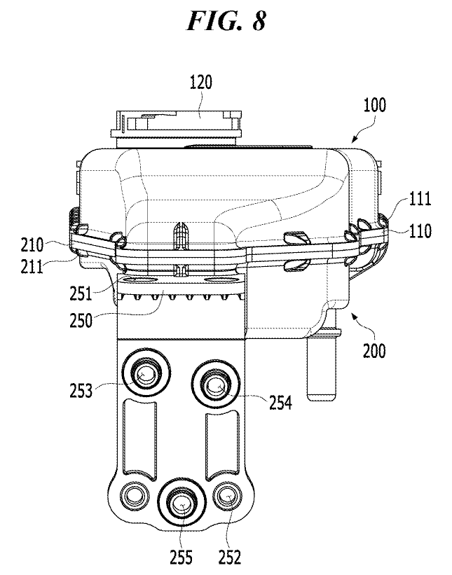

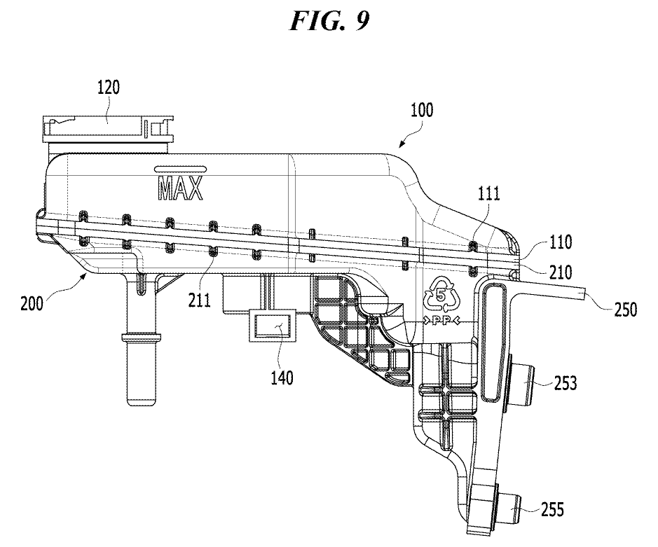

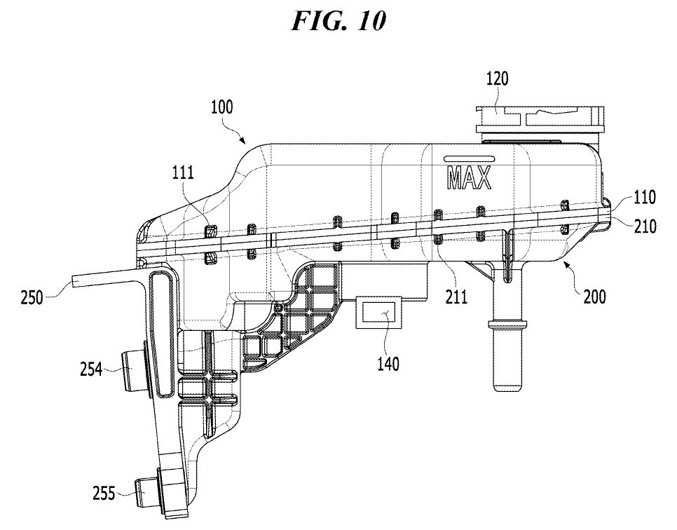

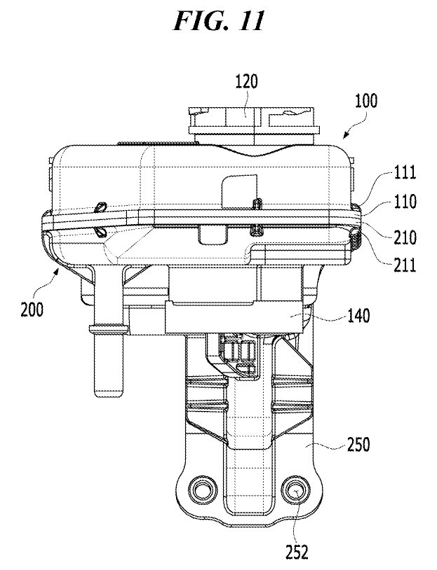

Meanwhile, FIGS. 2 and 3 are respectively a perspective top plan view and a perspective bottom plan view illustrating states in which the reservoir tank according to the embodiment of the present disclosure is disassembled. In addition, FIG. 4 is a top plan view illustrating an upper casing of the reservoir tank according to the embodiment of the present disclosure, and FIG. 5 is a bottom plan view illustrating a lower casing of the reservoir tank according to the embodiment of the present disclosure. In addition, FIGS. 6 and 7 are respectively a perspective top plan view and a perspective bottom plan view of the reservoir tank according to the embodiment of the present disclosure. In addition, FIGS. 8 to 11 are respectively a front view, a left side view, a right side view, and a rear view of the reservoir tank according to the embodiment of the present disclosure.

With reference to FIGS. 2 to 11, the reservoir tank according to the embodiment of the present disclosure includes an upper casing 100 and a lower casing 200 provided to form an internal space in which the brake oil is stored. In this case, the upper casing 100 and the lower casing 200 may be made by injection-molding the same synthetic resin material and coupled to each other by thermal bonding.

In addition, parting lines formed at a bottom surface side of the upper casing 100 and an upper surface side of the lower casing 200 to couple the upper casing 100 and the lower casing 200 may be inclined downward at a predetermined angle from the rear side to the front side. In this case, the parting lines may refer to coupling surfaces on which the upper casing 100 and the lower casing 200 are coupled by thermal bonding.

More specifically, the upper casing 100 may include an upper flange 110 formed along an outer peripheral surface of an opening formed at the bottom surface side. In addition, the upper casing 100 may include a plurality of upper reinforcement ribs 111 provided at preset intervals along an outer peripheral surface of the upper flange 110. In this case, the upper reinforcement rib 111 may extend upward by a preset height from an upper surface of the upper flange 110 along an outer surface of the upper casing 100 without protruding to the outside of the upper flange 110. For example, a height of the upper reinforcement rib 111 may be 1.2 to 3.5 times larger than a height of the upper flange 110 in accordance with the positions at which the upper reinforcement ribs 111 are formed.

In addition, the upper casing 100 may include a plurality of upper inner ribs 112 provided at preset intervals along an inner peripheral surface of the upper flange 110. In this case, the upper inner rib 112 may protrude and extend from the upper flange 110 toward the internal space so as to have a bottom surface identical to a bottom surface of the upper flange 110, and the upper inner rib 112 may extend to an inner upper surface of the upper casing 100 along an inner surface of the upper casing 100. In addition, the upper inner ribs 112 respectively disposed at two opposite sides of the upper casing 100 may be provided to define a straight line.

In this case, as illustrated in FIG. 4, the upper reinforcement ribs 111 and the upper inner ribs 112 are disposed in a staggered manner without being disposed on a straight line, which may improve the rigidity of the entire upper casing 100. In particular, during the processes of manufacturing the upper casing 100 by injection molding and ejecting the upper casing 100 from a mold, the upper reinforcement ribs 111 may prevent deformation of the upper casing 100, which may implement overall dimension stabilization of the upper casing 100.

In addition, the upper casing 100 may include a filter assembly 130, a gasket 140, and an injection port cap 150 that are provided at a side of an injection port 120.

The injection port 120 is a hole through which the brake oil is injected into the internal space from the outside, as described above. The injection port 120 may be formed at an upper rear side of the upper casing 100 and protrude upward so that the injection port cap 150 is attached to or detached from the injection port 120. In addition, the injection port 120 may be provided in a hollow cylindrical shape as a whole and include various structures such as protrusions and screw threads formed at an upper end and protruding outward along an outer peripheral surface so that the injection port cap 150 may be attached to or detached from the injection port 120.

The filter assembly 130 may include a filter frame 131 inserted and coupled into the internal space through the injection port 120, and a filter 132 attached to the filter frame 131 and configured to filter out foreign substances contained in the brake oil supplied through the injection port 120. To this end, the filter frame 131 may also include a structure such as a flange at an outer peripheral surface side so that the filter frame 131 may be seated on a flange or the like protruding inward from a lower end of an inner peripheral surface of the injection port 120.

The gasket 140 is interposed between an upper end of the injection port 120 and the injection port cap 150 and serves to prevent the brake oil, which is stored in the internal space, from leaking to the injection port 120. To this end, the gasket 140 may include an annular protrusion protruding downward so that the gasket 140 is pressed and seals the injection port 120 when the injection port cap 150 is fastened to the injection port 120 in a state in which the gasket 140 is in contact with an upper surface side of the injection port 120.

Meanwhile, as described above, the lower casing 200 may be fastened to a lower side of the upper casing 100 to form the internal space in which the brake oil is stored. The lower casing 200 may include a lower flange 210 formed along an outer peripheral surface of an opening formed at an upper surface side. In this case, a thickness of the lower flange 210 may be equal to a thickness of the upper flange 110.

In addition, the lower casing 200 may include a plurality of lower reinforcement ribs 211 provided at preset intervals along an outer peripheral surface of the lower flange 210. In this case, the lower reinforcement rib 211 may extend downward by a preset height from a bottom surface of the lower flange 210 along an outer surface of the lower casing 200 without protruding to the outside of the lower flange 210.

In addition, when the upper casing 100 and the lower casing 200 are coupled, the lower reinforcement rib 211 and the upper reinforcement rib 111 may be disposed on a straight line. That is, as illustrated in FIGS. 8 to 11, the upper reinforcement rib 111 and the lower reinforcement rib 211 may be respectively disposed at the upper and lower sides based on the coupling surface between the upper casing 100 and the lower casing 200 so as to define the straight line.

Therefore, the upper reinforcement rib 112 and the lower reinforcement rib 212 may be used as means for aligning the upper casing 100 and the lower casing 200 when the upper casing 100 and the lower casing 200 are coupled by thermal bonding. More specifically, the upper casing 100 and the lower casing 200 are coupled by thermal bonding in a state in which a jig is installed on the upper casing 100 along the upper reinforcement ribs 112 and a jig is installed on the lower casing 200 along the lower reinforcement rib 212, such that the upper flange 110 and the lower flange 210 may be accurately assembled.

In addition, like the upper reinforcement rib 111, a height of the lower reinforcement rib 211 may be 1.2 to 3.5 times larger than a height of the lower flange 210 in accordance with the positions at which the lower reinforcement ribs 211 are formed.

In addition, the lower casing 200 may include a plurality of lower inner ribs 212 provided at preset intervals along an inner peripheral surface of the lower flange 210. In this case, the lower inner rib 212 may protrude and extend from the lower flange 210 toward the internal space so as to have a bottom surface identical to a bottom surface of the lower flange 210, and the lower inner rib 212 may extend to an inner bottom surface of the lower casing 200 along an inner surface of the lower casing 200. In addition, the lower inner ribs 212 respectively disposed at two opposite sides of the lower casing 200 may be provided to define a straight line.

In this case, as illustrated in FIG. 5, the lower reinforcement ribs 211 and the lower inner ribs 212 are disposed in a staggered manner without being disposed on a straight line, which may improve the rigidity of the entire lower casing 200. In particular, during the processes of manufacturing the lower casing 100 by injection molding and ejecting the lower casing 100 from a mold, the lower reinforcement ribs 211 may prevent deformation of the lower casing 100, which may implement overall dimension stabilization of the lower casing 100.

In addition, when the upper casing 100 and the lower casing 200 are coupled as the upper flange 110 and the lower flange 120 are coupled by thermal bonding, the lower inner ribs 212 may be coupled to the upper inner ribs 112 by thermal bonding, such that the upper casing 100 and the lower casing 200 may be more securely coupled.

In addition, the lower casing 200 may include a float chamber 220 and a float 230 provided in the internal space. In addition, the lower casing 200 may further include a switch fastening part 240 used to couple a switch (not illustrated) for detecting oil to an outer lower side. In addition, the lower casing 200 may further include a hydraulic block fastening part 250 provided at a front outer side of the lower casing 200 so as to be fastened to a hydraulic block that constitutes the electronic brake system according to the present disclosure.

In addition, as described above, the parting line formed at the upper side by the lower flange 210 of the lower casing 200 may be provided to be inclined downward at a predetermined angle from the rear side to the upper side while corresponding to the parting line provided at the lower side of the upper casing 100.

As illustrated in FIGS. 2 and 5, the float chamber 220 may include a float guide 221 protruding upward from the inner bottom surface of the lower casing 200. In this case, the float guide 221 may be provided in a hollow cylindrical shape entirely opened upward and may further include a protrusion protruding inward from an inner peripheral surface side and configured to guide upward and downward movements of the float 230.

The float 230 may be provided in a cylindrical shape as a whole so that the float 230 is inserted into the float chamber 220 and moves upward or downward in accordance with a level of the brake oil stored in the internal space. In addition, the float 230 may include a float slot 231 elongated in a height direction at an outer peripheral surface side so that the protrusion of the float guide is inserted into the float slot 231. The float 230 may include a magnet (not illustrated) provided at a bottom surface side.

Therefore, the float 230 may be disposed in the float chamber 220 in a state in which the float 230 is surrounded by the float guide 221, and the float 230 may smoothly move upward or downward in accordance with the level of the brake oil stored in the internal space.

The switch fastening part 240 serves to fasten the switch configured to detect the level of the brake oil stored in the internal space, and the switch detects the level of the brake oil on the basis of a change in magnetic force generated by the magnet of the float 230 that moves upward or downward in the float chamber 220 in accordance with the level of the brake oil stored in internal space, as described above. The switch fastening part 240 may be formed at a lower side of the float chamber 220.

The hydraulic block fastening part 250 may be provided at an outer front side of the lower casing 200 to fasten the reservoir tank according to the present disclosure to the hydraulic block (not illustrated) or the like that constitutes the electronic brake system.

More specifically, the hydraulic block fastening part 250 may be provided in a flange shape that forms an outer wall of a front side of the lower casing 200, and the hydraulic block fastening part 250 may include first and second fastening holes 251 and 252 having central axes defined in different directions so that fastening members (not illustrated) are fastened in different directions. In addition, an imaginary straight line passing through a center of the first fastening hole 251 and an imaginary straight line passing through a center of the second fastening hole 252 intersect each other perpendicularly, such that the reservoir tank according to the present disclosure may be more securely fixed to the hydraulic block.

In addition, the hydraulic block fastening part 250 may include a first port 253, a second port 254, and a third port 255 provided to supply the brake oil, which is stored in the internal space, to the electronic brake system including the reservoir tank according to the present disclosure.

While the specific embodiments of the reservoir tank and the electronic brake system including the same according to the present disclosure have been described above, it is apparent that various modifications may be made without departing from the scope of the present disclosure.

Therefore, the scope of the present disclosure should not be limited to the described embodiments, and should be defined by not only the claims to be described below, but also those equivalent to the claims.

That is, it should be understood that the aforementioned exemplary embodiments are described for illustration in all aspects and are not limited, and the scope of the present disclosure shall be represented by the claims to be described below, and it should be construed that all of the changes or modified forms induced from the meaning and the scope of the claims, and an equivalent concept thereto are included in the scope of the present disclosure.

What claimed is:

1. A reservoir tank comprising:
an upper casing comprising an upper flange provided at a lower side thereof, and upper reinforcement ribs provided along an outer peripheral surface of the upper flange; and
a lower casing comprising a lower flange provided at an upper side thereof, and lower reinforcement ribs provided along an outer peripheral surface of the lower flange, the lower casing being coupled to the lower side of the upper casing to form an internal space in which brake oil is stored,
wherein the upper reinforcement rib and the lower reinforcement rib are disposed on a straight line.

2. The reservoir tank of claim 1, wherein the upper casing and the lower casing are provided by injection-molding a synthetic resin material.

3. The reservoir tank of claim 1, wherein the upper casing further comprises upper inner ribs protruding from the upper flange toward the internal space, and the lower casing further comprises lower inner ribs protruding from the lower flange toward the internal space.

4. The reservoir tank of claim 3, wherein the upper casing is coupled to the lower casing by thermally bonding upper surfaces of the lower flange and the lower inner ribs and bottom surfaces of the upper flange and the upper inner ribs.

5. The reservoir tank of claim 3, wherein the upper reinforcement rib extends upward by a preset height from an upper surface of the upper flange along an outer surface of the upper casing, and the lower reinforcement rib extends downward by a preset height from a bottom surface of the lower flange along an outer surface of the lower casing.

6. The reservoir tank of claim 5, wherein the upper reinforcement ribs and the upper inner ribs are disposed in a staggered manner in a longitudinal direction of the upper inner ribs extending from the upper flange, and the lower reinforcement ribs and the lower inner ribs are disposed in a staggered manner in a longitudinal direction of the lower inner ribs extending from the lower flange.

7. The reservoir tank of claim 1, wherein a height of the upper flange is equal to a height of the lower flange.

8. The reservoir tank of claim 7, wherein a height of the upper rib and a height of the lower rib are 1.2 to 3.5 times larger than a height of the upper flange or a height of the lower flange.

9. The reservoir tank of claim 1, wherein the upper casing further comprises:
an injection port provided at a rear upper side of the upper casing to inject the brake oil into the internal space;
a filter assembly provided to be detachable from the injection port toward the internal space;
a gasket provided at an upper side of the filter assembly and configured to cover the injection port; and
an injection port cap configured to open or close the injection port.

10. The reservoir tank of claim 1, wherein the lower casing further comprises:
a float chamber formed by a float guide provided in the internal space; and
a float inserted into the float chamber and configured to move upward or downward in accordance with a level of the brake oil stored in the internal space.

11. The reservoir tank of claim 10, wherein the float guide comprises a protrusion protruding from an inner peripheral surface toward the float chamber, and the float is provided in a cylindrical shape and comprises a float slot formed in an outer peripheral surface so that the protrusion is inserted into the float slot.

12. The reservoir tank of claim 10, wherein the float comprises a magnet provided at a bottom surface side, and the lower casing further comprises a switch fastening part provided adjacent to the magnet and configured to fasten a switch configured to detect the level of the brake oil, which is stored in the internal space, on the basis of a magnetic force generated by the magnet.

13. The reservoir tank of claim 1, wherein the lower casing further comprises:
at least one fastening hole; and
a hydraulic block fastening part comprising at least one port and provided at a front surface side of the lower casing.

14. The reservoir tank of claim 13, wherein the fastening holes comprise first and second fastening holes provided to have central axes intersecting each other perpendicularly.

15. An electronic brake system comprising:
a reservoir tank,
wherein reservoir tank comprises:
an upper casing comprising an upper flange provided at a lower side thereof, and upper reinforcement ribs provided along an outer peripheral surface of the upper flange; and
a lower casing comprising a lower flange provided at an upper side thereof, and lower reinforcement ribs provided along an outer peripheral surface of the lower flange, the lower casing being coupled to the lower side of the upper casing to form an internal space in which brake oil is stored, and
wherein the upper reinforcement rib and the lower reinforcement rib are disposed on a straight line.

16. The electronic brake system of claim 15, wherein the upper casing further comprises upper inner ribs protruding from the upper flange toward the internal space, the lower casing further comprises lower inner ribs protruding from the lower flange toward the internal space, and the upper casing is coupled to the lower casing by thermally bonding upper surfaces of the lower flange and the lower inner ribs and bottom surfaces of the upper flange and the upper inner ribs.

17. The electronic brake system of claim 15, wherein the upper reinforcement rib extends upward by a preset height from an upper surface of the upper flange along an outer surface of the upper casing, and the lower reinforcement rib extends downward by a preset height from a bottom surface of the lower flange along an outer surface of the lower casing.

18. The electronic brake system of claim 15, wherein a height of the upper flange is equal to a height of the lower flange.

19. The electronic brake system of claim 18, wherein a height of the upper rib and a height of the lower rib are 1.2 to 3.5 times larger than a height of the upper flange or a height of the lower flange.

20. The electronic brake system of claim 15, wherein the upper reinforcement ribs and the upper inner ribs are disposed in a staggered manner in a longitudinal direction of the upper inner ribs extending from the upper flange, and the lower reinforcement ribs and the lower inner ribs are disposed in a staggered manner in a longitudinal direction of the lower inner ribs extending from the lower flange.
